(19) United States
(12) Patent Application Publication
(10) Pub. No.: US 2016/0278358 A1
(43) Pub. Date: Sep. 29, 2016

(54) FISHING POLE POSITIONING STRAP AND METHOD

(71) Applicant: Timothy Edward Bogs, Sacramento, CA (US)

(72) Inventor: Timothy Edward Bogs, Sacramento, CA (US)

(21) Appl. No.: 15/077,228

(22) Filed: Mar. 22, 2016

Related U.S. Application Data
(60) Provisional application No. 62/138,976, filed on Mar. 27, 2015.

(51) Int. Cl. A01K 97/10; A01K 99/00

(52) U.S. Cl. CPC A01K 97/10; A01K 99/00

(57) ABSTRACT

A fishing pole positioning strap for maintaining the position of a fishing pole is provided. In some embodiments, the strap may include an elongate body having a proximal end, a distal end, a first surface, and a second surface. A first fastening element may be disposed on the first surface and a second fastening element may be disposed on the second surface. The first fastening element and second fastening element may be configured to be removably coupled together. A cushioning pad may be coupled to the first surface of the elongate body such as by being coupled proximate to the proximal end.

### CROSS REFERENCE TO RELATED APPLICATIONS

This application claims priority to and the benefit of the filing date of U.S. Provisional Application No. 62/138,976, filed on Mar. 27, 2015, entitled “Bogstrap Fishing Pole Balancing and Storage Strap”, which is hereby incorporated by reference in its entirety.

### FIELD OF THE INVENTION

This patent specification relates to the field of fishing pole positioning devices and methods. More specifically, this patent specification relates to devices and methods for positioning fishing poles being used for fishing and fishing poles being stored.

### BACKGROUND

Fishing, and especially float fishing and live bait fishing, is a sport that requires patience and persistence. Often, to be successful, a fisherman must maintain their fishing pole in a certain position for extended periods of time which can become tedious and tiresome. This problem is compounded for fishermen using more than one fishing pole to fish. To address this, fishing pole holders have been developed which are able to hold a fishing pole in a static position. However, maintaining a fishing pole in a static position does not yield the best fishing results as fish are able to detect resistance provided by a static pole. Some fishermen have attempted to balance fishing poles on pole holders to prevent fish from detecting resistance provided by a static pole by using tape or rubber bands to position a fishing pole on a pole holder so that it is balanced and able to move freely. Unfortunately, rubber bands can crack and fall apart, while tape can fall off or move in the sun to leave a stick residue on the pole.

Therefore, a need exists for novel fishing pole positioning devices and methods. A need also exists for novel devices and methods for positioning fishing poles being used for fishing and fishing poles being stored. There is a further need for novel fishing pole positioning devices and methods which are able to balance fishing poles on pole holders to prevent fish from detecting resistance provided by a static pole. A further need exists for novel fishing pole positioning devices and methods which are able to be readily and easily adjusted or moved as needed to maintain the appropriate balance of a fishing pole as the tidal flow or currents change when fishing. Finally, there exists a need for novel fishing pole positioning devices and methods which do not become damaged in the sun and are easily removed and attached to fishing poles.

### BRIEF SUMMARY OF THE INVENTION

A fishing pole positioning strap for maintaining the position of a fishing pole is provided. The strap may be used to maintaining the position of a fishing pole which is disposed on a fishing pole holder and to maintain the position of a fishing pole that has been separated into segments, such as halves, during storage, transport, and the like. In some embodiments, the strap may include an elongate body having a proximal end, a distal end, a first surface, and a second surface. A first fastening element may be disposed on the first surface and a second fastening element may be disposed on the second surface. The first fastening element and second fastening element may be configured to be removably coupled together. A cushioning pad may be coupled to the first surface of the elongate body such as by being coupled proximate to the proximal end. The cushioning pad may add lift for ease of pole balancing and also provide protection between poles when stored.

In further embodiments, the first fastening element and the second fastening element may comprise hook-and-loop type fasteners and the fishing pole positioning strap may be secured around a fishing pole and other objects by wrapping the strap around the fishing pole with the cushioning pad in contact with the fishing pole and removably coupling the first fastening element and the second fastening element together.

According to one aspect consistent with the principles of the invention, a method for maintaining the position of a fishing pole on a fishing pole holder with a fishing pole positioning strap is provided. The method may include positioning a cushioning pad of a fishing pole positioning strap in contact with a fishing pole proximate to the balance point of the fishing pole; wrapping the elongate body of the fishing pole positioning strap around the fishing pole and cushioning pad; removably coupling the first fastening element of the fishing pole positioning strap to the second fastening element of the fishing pole positioning strap; and disposing the fishing pole on the pole holder with the balance point of the fishing pole supported by the pole holder and with the fishing pole positioning strap proximate to the pole holder.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts a top front perspective view of an example of a fishing pole positioning strap according to various embodiments described herein.

FIG. 2—FIG. 2 illustrates a bottom rear perspective view of an example of a fishing pole positioning strap according to various embodiments described herein.

FIG. 3—FIG. 3 shows a sectional, through line 3-3 shown in FIG. 1, elevation view of an example of a fishing pole positioning strap according to various embodiments described herein.

FIG. 4—FIG. 4 depicts a perspective exploded view of an example of a fishing pole positioning strap according to various embodiments described herein.

FIG. 5—FIG. 5 illustrates a perspective view of an example of a fishing pole separated in half for storage with exemplary two fishing pole positioning straps securing and maintaining the position of the fishing pole halves according to various embodiments described herein.

FIG. 6—FIG. 6 shows a block diagram of an example of a method for maintaining the position of a fishing pole according to various embodiments described herein.

FIG. 7—FIG. 7 depicts a perspective view of an example of a fishing pole positioning strap secured to an exemplary fishing pole disposed on an exemplary fishing pole holder according to various embodiments described herein.

FIG. 8—FIG. 8 illustrates a perspective view of an example of a fishing pole positioning strap secured to an exemplary fishing pole that is balanced and able to move freely while disposed on an exemplary fishing pole holder according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

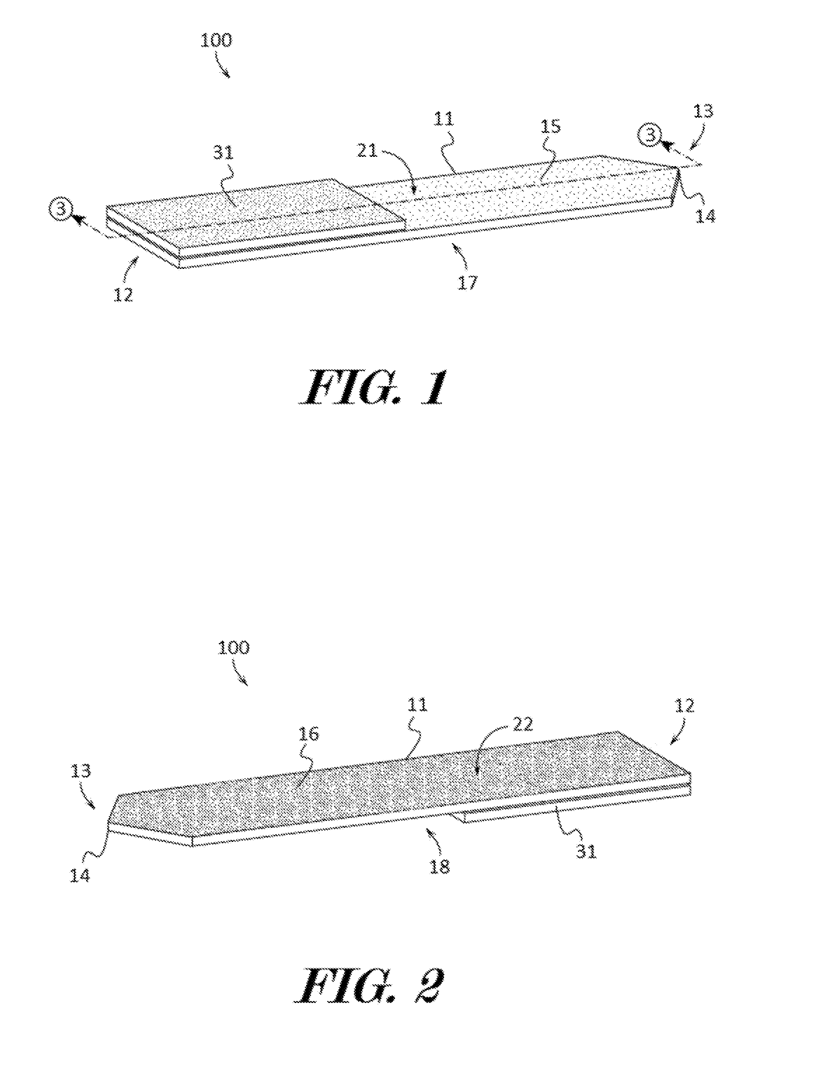

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

New fishing pole positioning straps and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

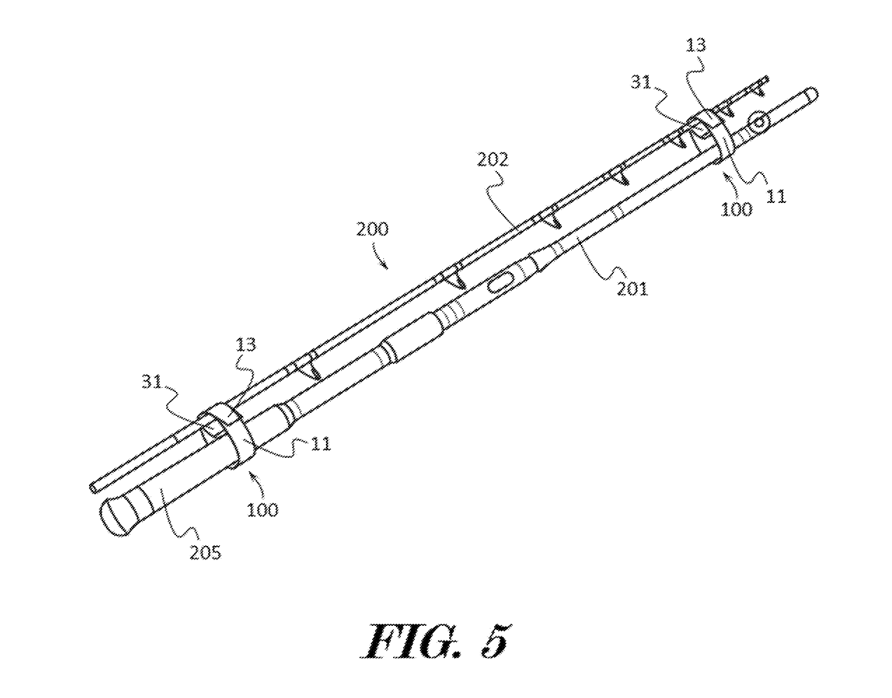

The present invention will now be described by example and through referencing the appended figures representing preferred and alternative embodiments. FIGS. 1-4 illustrate an example of a fishing pole positioning strap (“the strap”) 100 according to various embodiments. In this and some embodiments, the strap 100 may comprise an elongate body 11 having a proximal end 12, a distal end 13, a first surface 21, and a second surface 22. A first fastening element 15 may be disposed on the first surface 21 and a second fastening element 16 may be disposed on the second surface 22. The first fastening element 15 and second fastening element 16 may be configured to be removably coupled together. A cushioning pad 31 may be coupled to the first surface 21 of the elongate body 11 such as by being coupled proximate to the proximal end 12.

In some embodiments, the elongate body 11 may comprise a generally rectangular shape with a length that is generally greater than the width. The length of the elongate body 11, and therefore the strap 100, may be formed by a first major side 17 and a second major side 18. The first major side 17 and the second major side 18 may terminate at the proximal end 12 and the distal end 13. In further embodiments, the cushioning pad 31 may also be generally rectangular in shape comprising a length that is less than the length of the first major side 17 and second major side 18, while comprising a width that is generally equal to the width of the proximal end 12 and/or distal end 13. In still further embodiments, the cushioning pad 31 may comprise a width that is generally greater than the width of the proximal end 12 and/or distal end 13 and therefore greater than the width of the elongate strap 11. In even further embodiments, the cushioning pad 31 may comprise a width that is generally less than the width of the proximal end 12 and/or distal end 13 and therefore less than the width of the elongate strap 11.

In alternative embodiments, the elongate body 11 and/or cushioning pad 31 may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

In some embodiments, the distal end 13 of the elongate body 11 may be tapered to generally form a point 14. In alternative embodiments, the distal end 13 of the elongate body 11 may be tapered into a generally rounded shaped point 14. In still further alternative embodiments, the distal end 13 of the elongate body 11 may comprise two or more points 14 with portions of the elongate body 11 be tapered to form the points 14. Likewise, in some embodiments, the proximal end 12 of the elongate body 11 may be tapered to generally form a point 14. In alternative embodiments, the proximal end 12 of the elongate body 11 may be tapered into a generally rounded shaped point 14. In still further alternative embodiments, the proximal end 12 of the elongate body 11 may comprise two or more points 14 with portions of the elongate body 11 be tapered to form the points 14.

The elongate body 11 is configured to bend and conform to the shape of a fishing pole and other objects to allow the strap 100 to be wrapped around portions of a fishing pole 200 (FIGS. 5, 7, 8). In some embodiments, the elongate body 11 may be made from or comprise a flexible material such as nylon webbing. In other embodiments, the elongate body 11 may be made from or comprise a flexible material such nylon webbing, polypropylene webbing, polyester webbing, various types of flexible plastics such as polyvinyl chloride, natural or synthetic rubber, neoprene foam rubber, synthetic fabrics such as polyester, nylon, rayon, acetate, spandex, lastex, and Kevlar, and natural fabrics such as coir, cotton, hemp, jute, canvas, flax, leather, linen, ramie, wool, silk, or any other suitable flexible natural or synthetic material including combinations of materials. In further embodiments, the elongate body 11 may be formed from a first fastening element 15 and a second fastening element 16 which are integrally formed together, such as a hook-and-loop type fastener which has hooks on one side and loops on the other side.

In further embodiments, the elongate body 11 may be made from or comprise an elastic material to allow the elongate body 11 to flex and stretch to conform to the shape of a fishing pole and other objects to allow the strap 100 to be wrapped around portions of a fishing pole 200 (FIGS. 5, 7, 8). In some embodiments, the elongate body 11 may be made from or comprise an elastic material such as spandex, lastex, Lycra®, rubber, silicone rubber, elastic plastics, or any other material or combination or materials that are substantially able to regain their shape after deformation. In further embodiments, the elongate body 11 may be made from or comprise a braided elastic material, a woven elastic material, or a knitted elastic material. In still further embodiments, the elongate body 11 may be made from or comprise elastic materials including braided elastic fabric materials, woven elastic fabric materials, knitted elastic fabric materials, neoprene, spandex, elastane, cotton swimwear elastic, roll elastic, non-roll elastic, rubber, silicone, elastic plastics, elastic silicone, elastic rubbers, silicone rubbers, or any other suitable elastic, elastomer, or other resilient material.

The cushioning pad 31 is also configured to be resilient and conform to the shape of a fishing pole and other objects to allow the cushioning pad 31 to be wrapped around portions of a fishing pole 200 (FIGS. 5, 7, 8). Preferably, a cushioning pad 31 may be made from a resilient material that is able to act as a cushion. In some embodiments, a cushioning pad 31 may be made from or comprise a resilient material such as ARTiLAGE foams, Poron foams, silicone foams, rubber foams, plastic foams, neoprene foam, latex foam rubber, polyurenthane foam rubber, or elastomer materials such as elastic plastics, elastic silicone, elastic rubbers, silicone rubbers, or any other suitable elastomer or resilient material. In still further embodiments, a cushioning pad 31 may be made from a resilient material inclusive of hot glues that can be melted to create or build a cushioning pad 31.

As shown in FIGS. 1-3, the cushioning pad 31 may be coupled to the first surface 21 of the elongate body 11 proximate to the proximal end 12. In other embodiments, the cushioning pad 31 may be coupled to the first surface 21 of the elongate body 11 proximate to the distal end 13. In still other embodiments, one or more cushioning pads 31 may be coupled to anywhere to the first surface 21 of the elongate body 11. In alternative embodiments, the cushioning pad 31 may be coupled to the second surface 22 of the elongate body 11 proximate to the proximal end 12. In other embodiments, the cushioning pad 31 may be coupled to the second surface 22 of the elongate body 11 proximate to the distal end 13. In still other embodiments, one or more cushioning pads 31 may be coupled to anywhere to the second surface 22 of the elongate body 11.

In some embodiments, a cushioning pad 31 may be coupled to the elongate body 11 with stitching using a synthetic material and/or natural material thread, string, yard, rope, and the like. In other embodiments, a cushioning pad 31 may be coupled to the elongate body 11 with an adhesive such as Bisphenol A epoxy resin, Bisphenol F epoxy resin, Novolac epoxy resin, Aliphatic epoxy resin, Glycidylamine epoxy resin, other Multi-part adhesives, Cyanoacrylates, solvent-based adhesives, acrylic polymer based adhesives, polymer dispersion adhesives, polyurethane, contact adhesives, natural resins hot adhesives, one-part adhesives, or any other suitable adhesive. In still further embodiments, a cushioning pad 31 may be coupled to the elongate body 11 with an adhesive that is formed by melting with heat a portion of the cushioning pad 31 and/or elongate body 11 and then pressing the cushioning pad 31 and elongate body 11 together to allow the melted portion of the cushioning pad 31 and/or elongate body 11 to function as an adhesive.

The strap 100 is configured to be wrapped around and secured to portions of a fishing pole 200 (FIGS. 5, 7, 8) and/or other objects by removably coupling the first fastening element 15 and second fastening element 16 together. In some embodiments, the strap 100 may comprise one, two, three, four, five, six, seven, or more first fastening elements 15 which may be removably coupled to one, two, three, four, five, six, seven, or more second fastening elements 16. In preferred embodiments, the first 15 and second 16 fastening elements may comprise hook-and-loop type fastener system such as Velcro® and the like. A first fastening element 15 may be positioned on or coupled to the strap 100 anywhere on the elongate body 11 such as on all or a portion of the first surface 21. A second fastening element 16 may be positioned on or coupled to the strap 100 anywhere on the elongate body 11 such as on all or a portion of the second surface 22.

In further embodiments, the first fastening element 15 may comprise a hook type fastener of a hook-and-loop type fastener system and the second fastening element 16 may comprise a loop type fastener of a hook-and-loop type fastener system. In other embodiments, the first fastening element 15 may comprise a loop type fastener of a hook-and-loop type fastener system and the second fastening element 16 may comprise a hook type fastener of a hook-and-loop type fastener system. In alternative embodiments, a first fastening element 15 and/or a second fastening element 16 may comprise a press fit or snap fit fastener, magnetic type fastener, threaded type fastener, sealable tongue and groove fastener, snap fastener, clip type fastener, clasp type fastener, ratchet type fastener, watch strap type fastener, push-to-lock type fastener, turn-to-lock type connection fastener, slide-to-lock type fastener, or any other type of fasteners which may be removably coupled together. In still further embodiments, a first 15 or second 16 fastening element may comprise a series of apertures and the other fastening element 15, 16, may comprise a prong which may received into the apertures and a frame and bar similar to a belt buckle.

A first fastening element 15 and a second fastening element 16 may be positioned anywhere on the first surface 21 and/or second surface 22. In preferred embodiments, a first fastening element 15 may be positioned anywhere on the first surface 21 or on the second surface 22 while a second fastening element 16 may be may be positioned anywhere on the other or opposing surface 21, 22. In further embodiments, the distal end 13 of the elongate body 11 may be removably coupled to the second side 22 of the elongate body 11 by removably coupling a first fastening element 15 to a second fastening element 16. In other embodiments, the distal proximal end 12 of the elongate body 11 may be removably coupled to the second side 22 of the elongate body 11 by removably coupling a first fastening element 15 to a second fastening element 16.

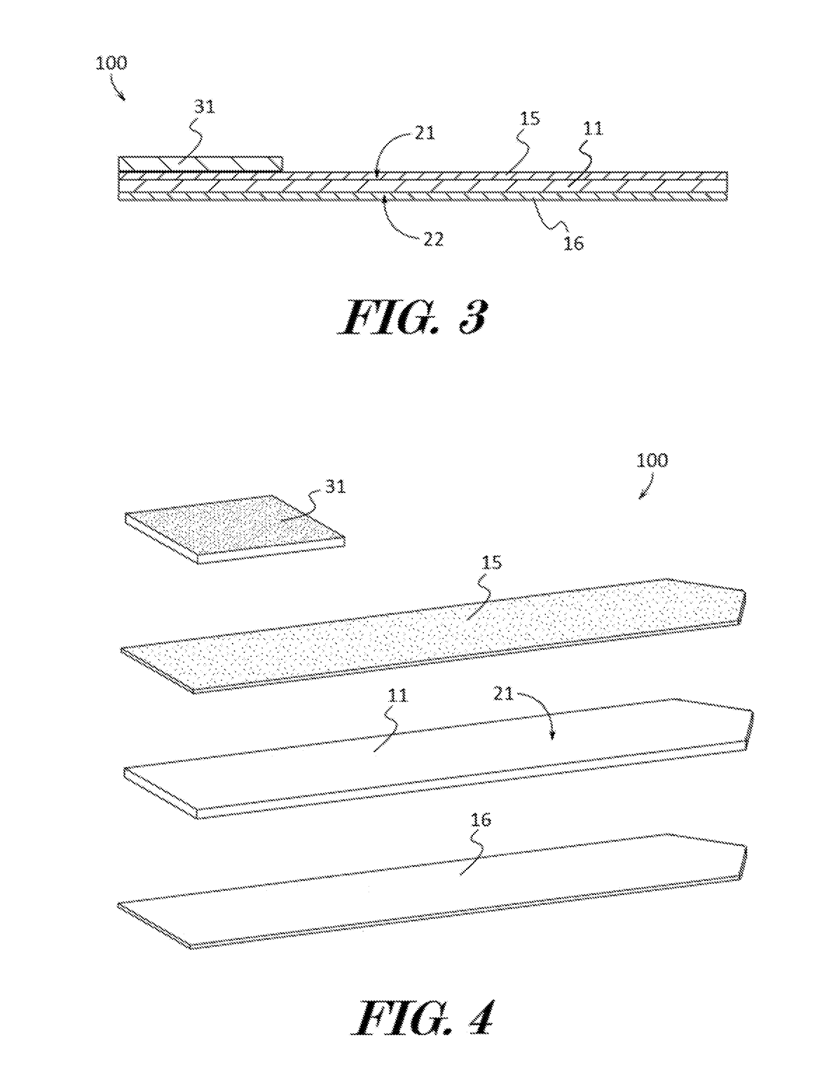

As perhaps best shown in FIG. 5, one or more straps 100 may be removably coupled to a fishing pole 200 which has been separated in half for storage to secure and maintain the position of the fishing pole halves 201, 202, such as during storage or transport of a fishing pole. In this example, the cushioning pad 31 which is coupled to the proximal end 12 of the elongate body 11 may be inserted between the two fishing pole halves 201, 202, to prevent the fishing pole halves 201, 202, from contacting each other. The elongate body 11, comprising a first fastening element 15 (FIGS. 1, 3, 4) and a second fastening element 16 (FIGS. 2 and 3), may then be wrapped around the fishing pole halves 201, 202. By removably coupling the first fastening element 15 and the second fastening element 16 together, the fishing pole halves 201, 202, may be maintained in position and secured together until the fastening element 15 and the second fastening element 16 are uncoupled and the elongate body 11 is unwrapped from around the fishing pole halves 201, 202. By wrapping the elongate body 11 around two or more objects, such as fishing pole halves 201, 202, and removably coupling the first fastening element 15 and the second fastening element 16 together, the objects may be maintained in position and secured together until the fastening element 15 and the second fastening element 16 are uncoupled and the elongate body 11 is unwrapped from around the objects. In further embodiments, three, four, five, six, seven or more straps 100 may be used to maintain in position and secure two or more objects together.

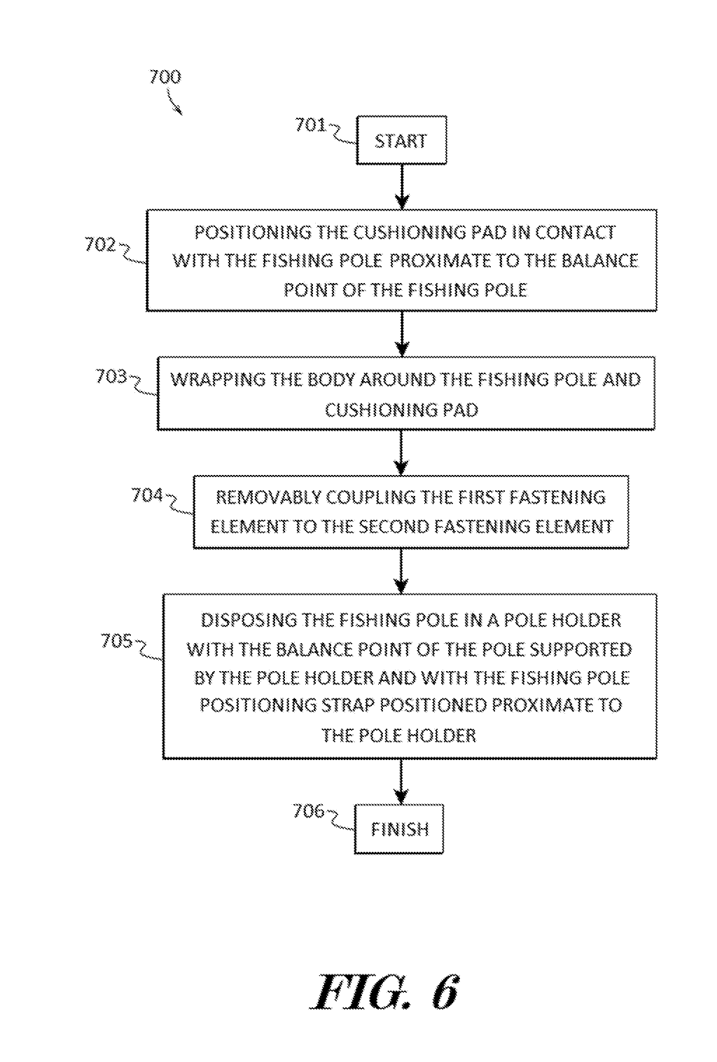

Referring now to FIG. 6, a block diagram of an example of a method for maintaining the position of a fishing pole (“the method 700”) according to various embodiments described herein is depicted. The method may be used to maintain the position of a fishing pole 200 on a fishing pole holder 300 with a fishing pole positioning strap 100 preferably to allow the fishing pole 200 to be balanced on the fishing pole holder 300 while the fishing pole 200 is being used for fishing activities.

In some embodiments, the method 700 may start 701 and the cushioning pad 31 may be positioned in contact with the fishing pole 200 proximate to the balance point 203 of the fishing pole 201 in step 702. The balance point 203 may describe the location on the fishing pole 200 in which the weight of the fishing pole 200 is equally distributed on both sides of the balance point 203 when the fishing pole 200 is resting on or being supported by the balance point 203. While fishing pole 200 designs vary greatly, they all comprise a balance point 203 that is easily determined simply by holding the fishing pole 200 in the hand. In preferred embodiments, the cushioning pad 31 may be positioned proximate to the balance point 203 on the side of the balance point 203 that is farther from the fishing reel 204 and fishing pole handle 205 of the fishing pole 200. In other embodiments, the cushioning pad 31 may be positioned proximate to the balance point 203 on the side of the balance point 203 that is closer to the fishing reel 204 and fishing pole handle 205 of the fishing pole 200.

Next in step 703, the elongate body 11 may be wrapped around the fishing pole 200 and around the cushioning pad 31. In preferred embodiments, the cushioning pad 31 may be wrapped around the fishing pole 200 as the elongate body 11 is wrapped around the fishing pole 200 so that the elongate body 11 encircles both the cushioning pad 31 and the fishing pole 200.

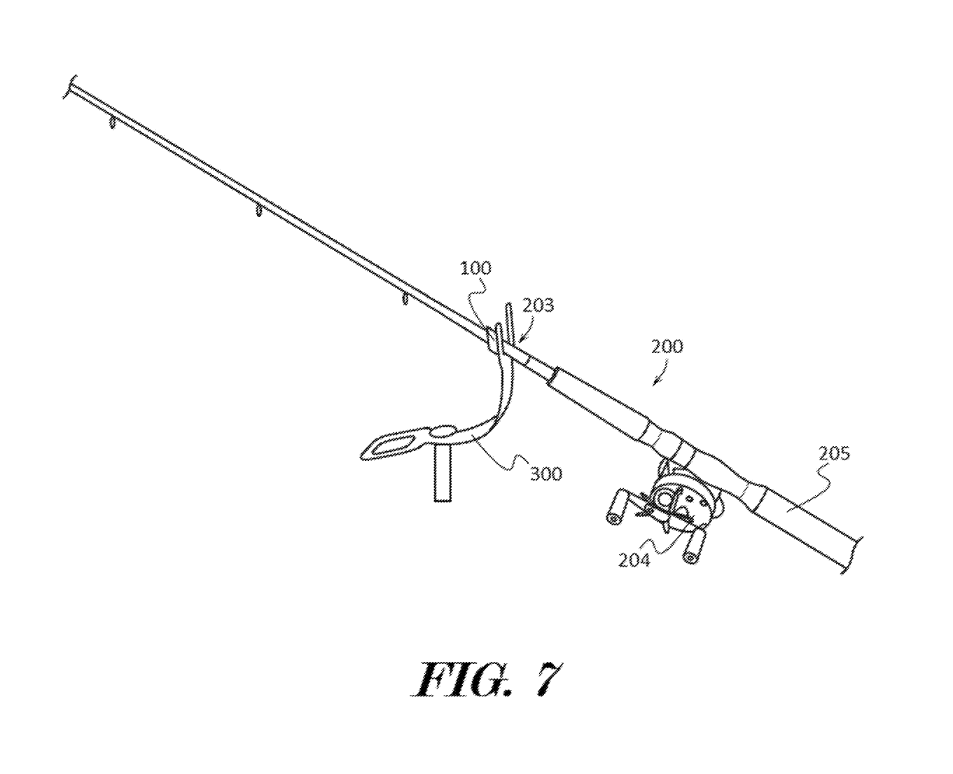

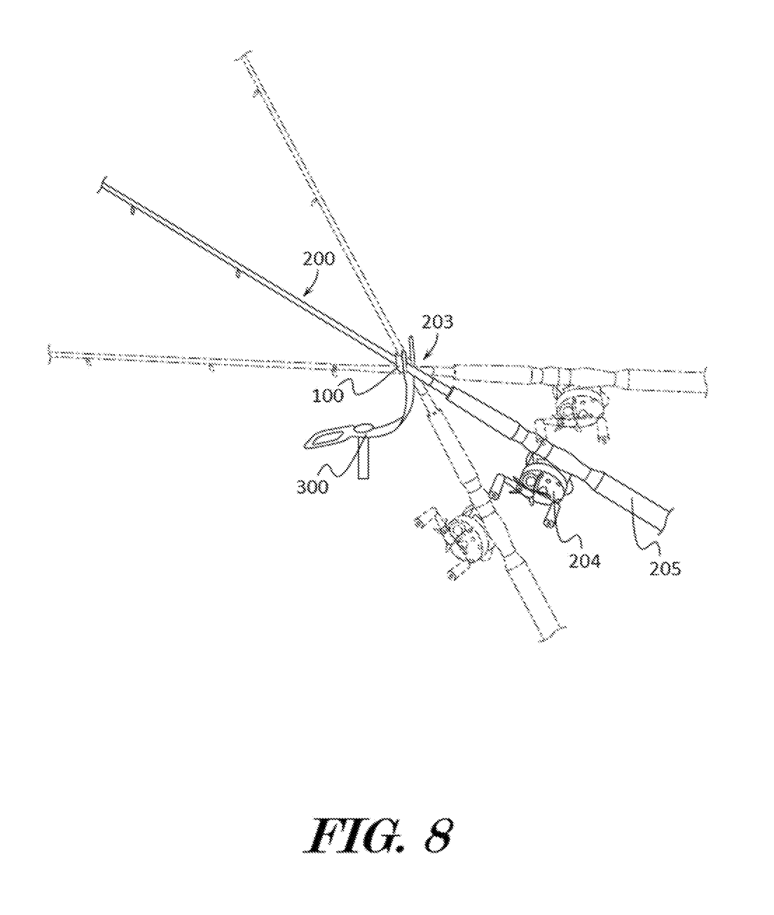

In step 704, the first fastening element 15 may be removably coupled to the second fastening element 16. By removably coupling the fastening elements 15, 16, together, the strap 100 may be secured to the fishing pole 200 as shown in FIGS. 7 and 8. In preferred embodiments, the elongate body may be tensioned as the first fastening element 15 is removably coupled to the second fastening element 16. Tensioning the elongate body 11 as the fastening elements 15, 16, are coupled together will increase the frictional resistance between the fishing pole 200 and the cushioning pad 31 thereby resisting the movement of the strap 100 relative to the balance point 203. In some embodiments, the fastening elements 15, 16, may comprise hook-and-loop type fasteners. In further embodiments, the fastening elements 15, 16, may comprise any type of fastener which may be used to removably couple the elongate body 11 around the fishing pole 200 and/or other object(s).

Next in step 705, the fishing pole 200 may be disposed on a fishing pole holder 300 with the balance point 203 of the fishing pole 200 supported by the pole holder 300 and with the fishing pole positioning strap 100 positioned proximate to the pole holder 300 as shown in FIGS. 7 and 8. By disposing the fishing pole 200 on the pole holder 300 so that the balance point 203 is supported by the pole holder 300, the fishing pole 200 may be allowed to move freely while on the pole holder 300 so that the fishing pole 200 may be used for balance fishing activities. Additionally, the strap 100 may preferably abut to the balance point 203 and/or the portion of the fishing pole holder 300 in contact with the balance point 203 to maintain the position of a fishing pole 200 on a fishing pole holder 300 such as during balance fishing activities. Once the fishing pole 200 is disposed on the pole holder 300 according to step 705, the method 700 may finish 706.

While some materials have been provided, in other embodiments, the elements that comprise the strap 100 such as the elongate body 11, cushioning pad 31, first surface 21, second surface 22, proximal end 12, distal end 13, first fastening element 15, second fastening element 16, and/or any other element discussed herein may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the strap 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the strap 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the strap 100 may be coupled by being one of connected to and integrally formed with another element of the strap 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A fishing pole positioning strap for maintaining the position of a fishing pole which is disposed on a fishing pole holder, the strap comprising:
a. an elongate body having a proximal end, a distal end, a first surface, and a second surface;
b. a first fastening element disposed on the first surface;
c. a second fastening element disposed on the second surface, wherein the second fastening element is configured to be removably coupled to the first fastening element; and
d. a cushioning pad coupled to the first surface of the elongate body proximate to the proximal end.

2. The strap of claim 1, wherein the distal end of the elongate body is tapered.

3. The strap of claim 1, wherein the cushioning pad is coupled to the elongate body with an adhesive.

4. The strap of claim 1, wherein the cushioning pad is coupled to the elongate body with stitching.

5. The strap of claim 1, wherein the cushioning pad comprises a resilient material selected from the group consisting essentially of ARTiLAGE foam, Poron foam, silicone foam, rubber foam, plastic foam, neoprene foam, latex foam rubber, polyurenthane foam rubber, elastic plastic, elastic silicone, elastic rubber, and silicone rubber.

6. The strap of claim 1, wherein the elongate body comprises a flexible material selected from the group consisting essentially of nylon webbing, polypropylene webbing, polyester webbing, flexible plastics, natural rubber, synthetic rubber, neoprene foam rubber, polyester, nylon, rayon, acetate, spandex, lastex, and Kevlar, coir, cotton, hemp, jute, canvas, flax, leather, linen, ramie, wool, and silk.

7. The strap of claim 1, wherein the elongate body comprises an elastic material selected from the group consisting essentially of spandex, lastex, latex, Lycra, rubber, silicone rubber, braided elastic material, a woven elastic material, a knitted elastic material, neoprene, spandex, elastane, cotton swimwear elastic, roll elastic, non-roll elastic, elastic plastic, elastic silicone, and elastic rubber.

8. The strap of claim 1, wherein the first fastening element comprises a hook type fastener, and wherein the second fastening element comprises a loop type fastener.

9. The strap of claim 1, wherein the first fastening element comprises a loop type fastener, and wherein the second fastening element comprises a hook type fastener.

10. The strap of claim 1, wherein the distal end of the elongate body is removably coupled to the second side of the elongate body by removably coupling the first fastening element to the second fastening element.

11. A method for maintaining the position of a fishing pole on a fishing pole holder with a fishing pole positioning strap, the strap comprising:
a. an elongate body having a proximal end, a distal end, a first surface, and a second surface;
b. a first fastening element disposed on the first surface;
c. a second fastening element disposed on the second surface, wherein the second fastening element is configured to be removably coupled to the first fastening element; and
d. a cushioning pad coupled to the first surface of the elongate body proximate to the proximal end; and
the method comprising the steps of:
e. positioning the cushioning pad in contact with the fishing pole proximate to the balance point of the fishing pole;
f. wrapping the elongate body around the fishing pole and cushioning pad;
g. removably coupling the first fastening element to the second fastening element;
and
h. disposing the fishing pole on a pole holder with the balance point of the fishing pole supported by the pole holder and with the fishing pole positioning strap proximate to the pole holder.

12. The method of claim 11, wherein the distal end of the elongate body is tapered.

13. The method of claim 11, wherein the cushioning pad is coupled to the elongate body with an adhesive.

14. The method of claim 11, wherein the cushioning pad is coupled to the elongate body with stitching.

15. The method of claim 1, wherein the cushioning pad comprises a resilient material selected from the group consisting essentially of ARTiLAGE foam, Poron foam, silicone foam, rubber foam, plastic foam, neoprene foam, latex foam rubber, polyurenthane foam rubber, elastic plastic, elastic silicone, elastic rubber, and silicone rubber.

16. The method of claim 11, wherein the elongate body comprises a flexible material selected from the group consisting essentially of nylon webbing, polypropylene webbing, polyester webbing, flexible plastics, natural rubber, synthetic rubber, neoprene foam rubber, polyester, nylon, rayon, acetate, spandex, lastex, and Kevlar, coir, cotton, hemp, jute, canvas, flax, leather, linen, ramie, wool, and silk.

17. The method of claim 11, an elastic material selected from the group consisting essentially of spandex, lastex, latex, Lycra, rubber, silicone rubber, braided elastic material, a woven elastic material, a knitted elastic material, neoprene, spandex, elastane, cotton swimwear elastic, roll elastic, non-roll elastic, elastic plastic, elastic silicone, and elastic rubber.

18. The method of claim 11, wherein the first fastening element comprises a hook type fastener, and wherein the second fastening element comprises a loop type fastener.

19. The method of claim 11, wherein the first fastening element comprises a loop type fastener, and wherein the second fastening element comprises a hook type fastener.

20. The method of claim 11, wherein the distal end of the elongate body is removably coupled to the second side of the elongate body by removably coupling the first fastening element to the second fastening element.
